(19) United States
(12) Patent Application Publication
(10) Pub. No.: US 2006/0109808 A1
(43) Pub. Date: May 25, 2006

(54) Digital broadcasting in areas with poor transmitting power

(75) Inventor: Rudolf Ritter, Zollikofen (CH)

Correspondence Address: OBLON, SPIVAK, MCCLELLAND, MAIER & NEUSTADT, P.C., 1940 DUKE STREET, ALEXANDRIA, VA, 22314, US

(73) Assignee: SWISSCOM MOBILE AG, Bern (CH)

(21) Appl. No.: 11/283,860

(22) Filed: Nov. 22, 2005

(30) Foreign Application Priority Data
Nov. 22, 2004 (EP) 04105974.2

(51) Int. Cl. H04J 3/08; H04J 3/22; H04B 7/14; H04J 3/16; H04J 1/10

(52) U.S. Cl. 370/315; 370/465

(57) ABSTRACT

The invention relates to a method, a mobile communication device, a device and a system for transmission of programs and/or data, which are disseminated by a broadcast transmitter, broadcast signals being received by a mobile communication device in a first transmission area having a first reception power and in a second transmission area having a second reception power, at which mobile communication device a retransmission unit receives broadcast signals in the first transmission area, converts them and transfers them to a local wireless network in the second transmission area. After logging into the local wireless network, the broadcast programs and/or broadcast data are received by the mobile communication device over the local wireless network.

### BACKGROUND OF THE INVENTION

1. Field of the Invention

The present invention relates to a method, a device, a mobile communication device and a system for transmission of programs and/or data, which are disseminated unidirectionally by a broadcast transmitter. In particular, the present invention relates to a method, a device, a mobile communication device and a system for transmission of programs and/or data in areas with poor transmission reception ability.

2. Background of the Invention

Already in use today in many places are broadcast systems with broadcast transmitters and broadcast receivers, in which digital audio programs (radio programs), respectively video programs (television programs), and digital data, for instance data for the performance of data services or program-associated data with reference to the respective programs (Program Associated Data, PAD), are disseminated by the broadcast transmitters unidirectionally. These digital audio or video programs are thereby transmitted by means radio waves of terrestrial or satellite-based transmitters, for example, or via broadcast cable networks, and are received by corresponding broadcast receivers. Such broadcast systems are known, for instance, by the designation Digital Audio Broadcasting (DAB), or Digital Video Broadcasting (DVB). Different designs exist within the DVB standard, such as DVB-C (cable), DVB-S (satellite), DVB-T (terrestrial) or DVB-H (for so-called handheld devices).

By means of DAB and DVB broadcast systems, particularly radio or television programs can be disseminated, but also interactive multimedia contents, for example games. An especially advantageous situation results in particular from the combination of digital broadcasting with receiving by means of portable and mobile devices. In this combination, users can receive audio or video programs anywhere without being connected to a fixed place.

These broadcast systems have the drawback, however, that the broadcast signals in certain areas can only be received poorly or not at all, for example because of an unfavorable topographical character of the region, high impediments or shielding inside houses and buildings from outside walls, inside walls, metallized windows and other insulators. Thus one of the essential advantages of broadcast systems, i.e. access to a very large audience, can be only partially exploited. This drawback seems all the more significant since there are nevertheless many broadcast receivers normally located in these areas with poor transmitting power, and these receivers are thus only able to gain poor access to the disseminated programs and/or data, or no access at all, whereby, in turn, expectations relating to quality of digital broadcasting are not met.

A further drawback of these broadcast systems results from the unidirectional dissemination characteristic of the broadcast signals, so that, for instance with transmission by means of radio waves, a feedback channel is lacking from the broadcast receivers to the broadcast transmitters, respectively to their operators. Thus no broadcast programs can be selected that are then received via the broadcast medium, for example. To make communication between the broadcast receivers and broadcast transmitters possible, separate, parallel channels have to be provided for transport of data from the mobile communication device to the broadcast provider, making putting into operation and maintenance of such systems additionally complicated and more expensive.

### SUMMARY OF THE INVENTION

It is an object of the present invention to propose a new and better method, a new and better device, a new and better mobile device as well as a new and better system suitable for the dissemination of programs and/or data that are disseminated unidirectionally by a broadcast transmitter, and which do not have in particular the above-mentioned drawbacks.

These objects are achieved according to the present invention through the elements of the independent claims. Further advantageous embodiments follow moreover from the dependent claims and from the description.

In particular these objects are attained through the invention in that for the transmission of programs and/or data that are disseminated unidirectionally by a broadcast transmitter in a first transmission area having a first reception power and in a second transmission area having a second reception power programs and/or data are received in the first transmission area by a receiving module of a retransmission unit, in that the programs and/or data are converted by means of a conversion module of the retransmission unit, in that the mobile communication device connects itself to an access node of a local wireless network, and in that the converted programs and/or data are transmitted via a communication interface of the retransmission unit to the local wireless network in the second transmission area, and are received there by the mobile communication device via an interface to the local wireless network. The reception power in the respective areas relates in particular to the signal strength and/or signal quality able to be received by a mobile communication device. In particular, the advantage of this invention lies in the fact that programs and/or data which are disseminated by the broadcast provider are also received in areas having poor reception power. Thus in particular the mobility of the user is not affected since by means of this invention a change of location from the first transmission area into the second transmission area, for example buildings which are shielded by metallized windows, becomes possible without any difficulties.

In an embodiment variant, the programs and/or data that are disseminated by the broadcast transmitter are received in the second transmission area either via an interface of the mobile communication device to the local wireless network, or directly via the broadcast interface. This has the advantage, among other things, that it is possible to select alternatively between two different receiving modes, depending upon the better quality of reception, in portions of the second transmission area where the broadcast signal has sufficient reception power. If, for instance, the desired program is receivable via the broadcast channel only in mono quality, but is receivable in stereo quality via the local wireless network, the mobile communication device can switch reception over to the local wireless network. Another advantage of this embodiment variant is the possibility of receiving simultaneously different programs and/or data via different channels.

In another embodiment variant, used for receiving broadcast programs and/or data is a mobile radio device for a GSM and/or UMTS mobile radio network, which is identified in the mobile radio network by means of an identification module. This embodiment variant has the advantage, among others, that by means of this additional function, existing mobile radio devices become devices which can be used in different environments for various applications. In particular, identification mechanisms of the mobile radio network can be used for identification and authentication purposes.

In a further embodiment variant, disseminated are broadcast programs and/or data of the DAB (Digital Audio Broadcast), DVB (Digital Video Broadcast), DVB-H (Digital Video Broadcast for Handhelds) and/or GPS type. This has the advantage, among others, that by means of this invention in particular the time components of the GPS signals can be transmitted in areas having an insufficient reception power. Reception of precise time information is thereby made possible, also in areas which are inaccessible even today, for instance.

In still another embodiment variant, control and/or monitoring data of the mobile communication device are transmitted at least partially over the local wireless network to a communication module of the broadcast provider. This has the advantage, among others, that the bidirectional local wireless network is used not only for receiving, but also for transmitting data, whereby feedback information can be transmitted to the broadcast transmitter. No additional feedback channel needs to be provided whereby the installation and maintenance of this broadcast system becomes simpler and less expensive.

In a further embodiment variant, a mobile radio network interface of the mobile communication device is used as the fallback interface to the communication module of the broadcast provider. This has the advantage, among others, that the control and/or monitoring data from the mobile communication device can reach the broadcast provider over the local wireless network even in the case of transmission difficulties. The probability that the broadcast system cannot be used to its full capacity is thereby reduced even further.

In a further embodiment variant, the programs and/or data to be disseminated are selected by means of an input device on the mobile communication device. This embodiment variant has the advantage, among others, that the user can determine directly at his mobile communication device which programs and/or data he would like to receive, based on his needs and interests, and that this is not defined centrally in the same way for all users.

In a further embodiment variant, upon entry into the second transmission area, a transmission request is sent to the retransmission unit from the mobile communication device for retransmission of programs and/or data, whereby the desired programs and/or data are then retransmitted by the retransmission unit to the mobile communication device over the local wireless network in the second transmission area. This has the advantage, among others, that the bandwidth in the local wireless network in the second transmission area is not used unnecessarily for retransmission of programs and/or data when no user would like to receive programs and/or data, and capacity is thereby freed up for other applications.

It should be stated here that besides the method according to the invention, the present invention also relates to a system, a mobile communication device and a device for carrying out the method.

### BRIEF DESCRIPTION OF THE DRAWINGS

FIG. 1 shows a schematic block diagram of a communication system, in which there are a broadcast provider, a broadcast transmitter, a mobile terminal, as well as a device for retransmission of broadcast signals from the first transmission area into the second transmission area.

FIG. 2 shows a block diagram representing schematically a device for retransmission of broadcast signals from a first transmission area into a second transmission area.

FIG. 3 shows a block diagram representing schematically a mobile terminal which is provided with interfaces for receiving programs and/or data in the first transmission area and in the second transmission area.

### DETAILED DESCRIPTION OF THE PREFFERED EMBODIMENTS

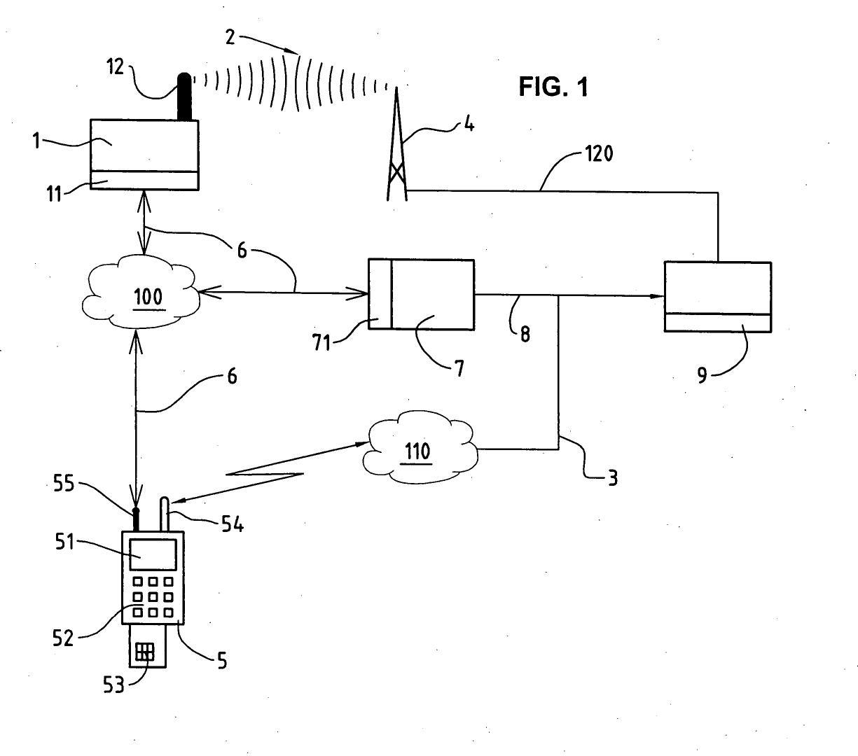

FIG. 1 illustrates an architecture that can be used to achieve the transmission of broadcast programs and/or broadcast data according to the invention. FIG. 1 shows a block diagram illustrating schematically a method and system according to the invention for digital broadcasting in areas having poor reception power. In FIG. 1, the reference numeral 9 refers to a central unit of a broadcast provider, which disseminates programs and/or data unidirectionally, for instance by means of radio waves from a terrestrial or satellite-based broadcast transmission antenna 4 via an air interface 2, or over broadcast cable networks. Designated by the reference numeral 9 is also the supplier of these programs and/or data, for example digital audio programs (radio programs), or respectively video programs (television programs), and digital data, for example data for performing data services or program-associated data relating to the respective programs (Program Associated Data, PAD), or also data in general (Non Program Associated Data, NPAD), for instance with interactive contents such as games. Meant in particular thereby are also multimedia data, e.g. in the MPEGX (in particular MP2/MPEG7) standard, as they are defined by the Moving Picture Experts Group. However, for better clarity, it should be mentioned here that a multiplicity of different vendors/suppliers can disseminate their programs and/or data via a common broadcast provider 9.

The broadcast provider 9 disseminates programs and/or data unidirectionally, for example by means of radio waves from a terrestrial or satellite-based broadcast transmission antenna 4 over an air interface 2, or over broadcast cable networks. A mobile communication device 5 has available the necessary infrastructure, including hardware and software components, to achieve a method and/or system according to the invention as described. Understood by mobile communication devices 5 are, among other things, all possible so-called Customer Premise Equipment (CPE), also comprising, for instance, all IP-capable devices, such as e.g. mobile radio telephones, PDAs, laptops or game consoles, for example Playstation®, Xbox®, Gameboy® or Gamecube®. In particular, the mobile communication device 5 is equipped with a broadcast receiver 510, by means of which the programs and/or data disseminated by the broadcast provider 9 are able to be received over broadcast channels, for instance over the broadcast cable network, or as radio waves over the air interface 2 by means of a broadcast receiving antenna 56. Broadcast systems with such broadcast transmitters and broadcast receivers are known, for example, by the designation Digital Audio Broadcasting (DAB), or respectively Digital Video Broadcasting (DVB). The standard ETS 300 401 “Radio broadcasting systems; Digital Audio Broadcasting (DAB) to mobile, portable and fixed receivers” has been defined by the European Telecommunications Standards Institute (ETSI), Sophia Antipolis, France, for the Digital Audio Broadcasting (DAB) system, which was developed for transmission of high quality digital audio programs and/or data services to be received by means of mobile, portable and fixed installed terminals from terrestrial or satellite-based transmitters 4 or from broadcast cable networks. The content of the document concerning this matter ETS 300 401, which was published in May 1997 by the ETSI in the second edition, and the content of the standard document ETS 300 174 “Network Aspects (NA); Digital Coding of Component Television Signals for Contribution Quality Applications in the Range 34-45 Mbit/s,” which was published by the ETSI in November 1992, are hereby incorporated into this text by reference. In the above-mentioned ETSI standards, a Fast Information Channel (FIC) is also defined by means of which a broadcast receiver 103 is able to obtain quicker access to information. Transmitted over the FIC channel are, for example, Multiplex Configuration Information (MCI), but also service information and data for data services.

In addition, the mobile communication device 5 possesses at least one further physical network interface that can also support a multiplicity of different network standards. These physical network interfaces can be interfaces to local wireless networks, for example, in particular WLAN (Wireless Local Area Network) 802.11, Bluetooth, and/or GSM (Global System for Mobile Communication), GPRS (Generalized Packet Radio Service), USSD (Unstructured Supplementary Services Data), WCDMA (Wideband Code-Division Multiple Access), UMTS (Universal Mobile Telecommunications System), as well s Ethernet, Token Ring and/or another wired LAN (Local Area Network). The reference numeral 100 in FIG. 1 thus stands for the various local wireless networks (WLAN 802.1.1, Bluetooth etc.), whereas the reference numeral 55 refers to the physical network interface of the mobile communication device 5 to these local wireless networks 100. Correspondingly, the reference numeral 110 stands for the various mobile radio networks (GSM, GPRS, UMTS etc.), and the reference numeral 54 stands for the corresponding physical network interface of the mobile communication device 5 to these mobile radio networks 110. In principle, it is to be said that the method and/or system according to the invention as well as the transmission device according to the invention are not bound to a specific network standard as long as the features according to the invention are present, but can instead be achieved with one or more of any desired networks, in particular also by the mobile communication device 5 switching transparently between the different networks. In this respect the mobile communication device 5 can support in particular specifications of the standards for seamless switching of language and data carrier services, such as e.g. UMA (Unlicensed Mobile Access) for the seamless transition between WLAN, GSM/GPRS and Bluetooth, SCCAN (Seamless Converged Communication Across Networks) or Bluephone.

Furthermore the mobile communication device is connected via a contact interface to an identification module 53 for identification of the mobile communication device 5 in the mobile radio network 110. In particular this identification module 53 can be an SIM card (Subscriber Identity Module) which is able to contain user-relevant data. The mobile communication device 5 possesses moreover input elements 52 by means of which data and/or commands can be entered for use and/or execution on the mobile communication device 5 or for transmission over the communication interfaces 54/55. In addition, the mobile communication device 5 has at its disposal elements 51 which are used for emission and/or reproduction of acoustical and/or optical signals as well as picture and/or sound data for the user. In particular the elements 51 can be used for emission and/or reproduction of received broadcast programs and/or broadcast data.

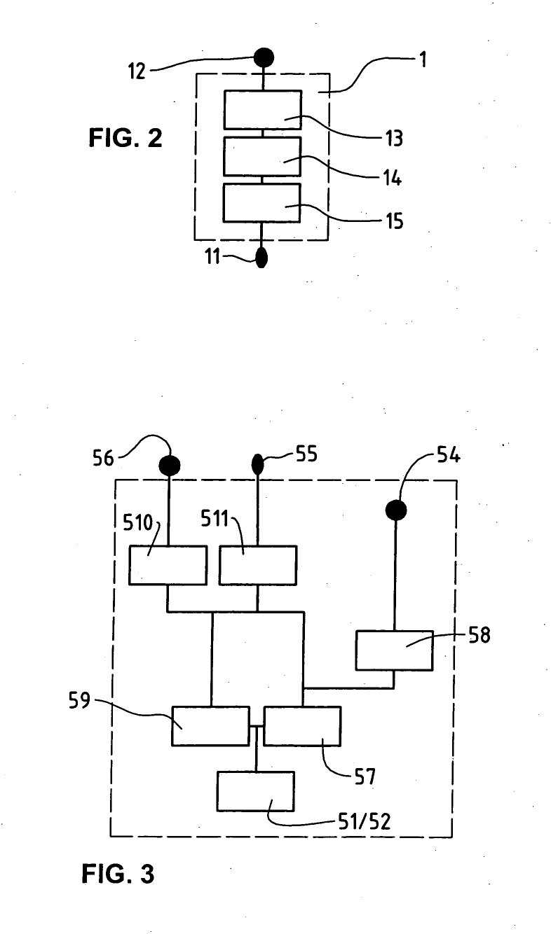

The reference numeral 1 in FIG. 2 refers to a retransmission unit whose receiving module 13 receives over a corresponding physical broadcast interface 12 broadcast programs and/or broadcast data that are disseminated from a broadcast transmission antenna 4 via an air interface 2 or via broadcast cable networks in a first transmission area. The thus received programs and/or data are retransmitted from the receiving module 13 of the retransmission unit 1 to a conversion module 14 of the retransmission unit 1. The conversion module 14 transforms the received programs and/or data by translating them into another frequency range. The programs and/or data can thereby be also subjected to other conversions, especially digitalization, filtering, etc. Moreover the data can also be converted such that they correspond to another standard or communication protocol. The thus converted programs and/or data are then retransmitted via a communication interface 15 of the retransmission unit 1 on the local wireless network 100 in the second transmission area.

According to FIG. 1, the reception of digitally broadcast programs and/or data can also be ensured in areas with poor reception power. Upon entry of the mobile communication device 5 into a transmission area having a poorer reception power of the broadcast signals which are transmitted by the broadcast transmission antenna 4, the mobile communication device 5 searches for available networks, and, in the case of available networks, logs into an access node of the respective network. In particular the mobile communication device 5 can log into a local wireless network 100. Afterwards the programs and/or data which are disseminated by the broadcast transmission antenna 4 and are retransmitted by the retransmission unit 1 onto the local wireless network 100 are received by the mobile communication device 5 in this area with poor reception power via the corresponding communication interface 55.

By means of input elements 52 of the mobile communication device 5, data and/or commands are entered which are transmitted via a feedback channel 8 and/or 3 to a central unit of the broadcast provider 9. These data and/or commands, in particular control and/or monitoring data, are transmitted via the corresponding physical interface 55 and/or the interface 54 to the local wireless network 100. The reference numeral 7 refers to a gateway which connects the local wireless network 100 to a central unit of the broadcast provider 9, so that the entered data and/or commands can be transmitted from the mobile communication device 5 to the central unit of the broadcast provider 9. In particular cable connections such as e.g. ISDN, DSL or PSTN connections, but also wireless connections via GSM, GPRS, UMTS or similar wireless transmission technologies can be used for connection of the gateway to the central unit of the broadcast provider 9. The feedback channel 3 is a fallback interface by means of which data and/or commands can be transmitted from the mobile communication device 5 to the central unit of the broadcast provider 9 via the mobile radio network.

It is to be mentioned that in an extended embodiment of the above-mentioned embodiment example, programs and/or data which are disseminated by the broadcast transmission antenna 4 and are received by a receiving module 13 of the retransmission unit 1 are retransmitted onto the local wireless network 100 only after a request from the mobile communication device 5.

1. A method for transmitting programs and/or data, said method comprising the steps of:
transmitting programs and/or data by a broadcast transmitter to a first transmission area having a first reception power and to a second transmission area having a second reception power;
receiving programs and/or data in the first transmission area by a receiving module of a retransmission unit;
converting the programs and/or data by a conversion module of the retransmission unit;
connecting a mobile communication device to an access node of a local wireless network having bidirectional communication in the second transmission area;
retransmitting the programs and/or data in the second transmission area via a communication interface of the retransmission unit to the local wireless network; and
receiving programs and/or data in the second transmission area by the mobile communication device via an interface of the mobile communication device to the local wireless network.

2. The method according to claim 1, wherein the programs and/or data are received in the second transmission area by the mobile communication device via the interface of the mobile communication device to the local wireless network and/or via the broadcast interface.

3. The method according to claim 1, wherein the mobile communication device is a mobile radio device for a GSM and/or UMTS mobile radio network, which mobile radio device is identified in the mobile radio network by an identification module.

4. The method according to claim 1, wherein the programs and/or data are of a type belonging to the group comprising DAB (Digital Audio Broadcast), DVB (Digital Video Broadcast), DVB-H (Digital Video Broadcast-Handheld) and GPS (Global Positioning System) types.

5. The method according to claim 1, wherein the mobile communication device transmits control and/or monitoring data at least partially via the local wireless network to a communication module of a broadcast provider.

6. The method according to claim 1, wherein the mobile communication device includes a mobile radio network interface used as a fallback interface to the communication module of a broadcast provider.

7. The method according to claim 1, wherein the mobile communication device includes an input device for selecting the programs and/or data to be disseminated.

8. The method according to claim 1 further comprising the steps of:
transmitting a request for transmission of programs and/or data to the retransmission device from the mobile communication device upon entry into the second transmission area, and
retransmitting the requested programs and/or data from the retransmission unit via the local wireless network to the mobile communication device.

9. A device configured to retransmit programs and/or data, comprising:
a receiving module configured to receive programs and/or data in a first transmission area,
a conversion module configured to convert programs and/or data into a different form, and
an interface configured to retransmit converted programs and/or data over a bidirectional local wireless network in a second transmission area.

10. The device according to claim 9, wherein the programs and/or data are of the DAB (Digital Audio Broadcast) and/or DVB (Digital Video Broadcast) and/or DVB-H (Digital Video Broadcast-Handheld) and/or GPS type.

11. The device according to claim 1, wherein the local wireless network in the second transmission area is a WLAN 802.11 network and/or a Bluetooth network.

12. A mobile communication device, comprising:
at least one interface to a local wireless network having bidirectional communication; and
at least one broadcast interface configured to receive programs and/or data that are disseminated unidirectionally by a broadcast transmitter in a first transmission area having a first transmitting power and in a second transmission area having a second transmitting power, wherein
the mobile communication device upon entry into the second transmission area prompts the transmission unit to transmit programs and/or data over the local wireless network, whereby the transmission unit transmits the requested programs and/or data to the mobile communication device via the local wireless network.

13. A transmission system comprising:
at least one broadcast transmitter, configured to disseminate programs and/or data unidirectionally
at least one retransmission device, which receives programs from the broadcast transmitter in a first transmission area having a first receiving power and retransmits the programs and/or data from a first transmission area having a first receiving power into a second transmission area having a second receiving power, the programs and/or data being retransmitted in the second transmission area to the mobile communication device via a bidirectional local wireless network;
a communication module of the broadcast provider as well as communication modules configured to facilitate communication of the mobile communication device with the communication module of the broadcast provider, wherein
the communication device comprises input elements which transmit input elements selection data, used to select the programs and/or data to be transmitted, to the communication module of the broadcast provider.

14. The device according to claim 9, wherein the local wireless network in the second transmission area is a WLAN 802.11 network and/or a Bluetooth network.

15. The device according to claim 12, wherein the local wireless network in the second transmission area is a WLAN 802.11 network and/or a Bluetooth network.
